(19) United States
(12) Patent Application Publication
(10) Pub. No.: US 2026/0184553 A1
(43) Pub. Date: Jul. 2, 2026

(54) HANDHELD BOTTLE OPENER FOR AIRLINE FLIGHT ATTENDANTS AND A METHOD THEREFOR

(71) Applicants: Tammy Fritts, Pittsburgh, PA (US); Cynthia Grambo, Pittsburgh, PA (US)

(72) Inventors: Tammy Fritts, Pittsburgh, PA (US); Cynthia Grambo, Pittsburgh, PA (US)

(21) Appl. No.: 19/001,948

(22) Filed: Dec. 26, 2024

(51) Int. Cl. B67B 7/44; B67B 7/16; B67B 7/40

(52) U.S. Cl. CPC B67B 7/44; B67B 7/16; B67B 7/403

(57) ABSTRACT

A handheld bottle opener for flight attendants includes a crosspiece, a first leg, and a second leg. The first leg is attached to and extends from the crosspiece. The first leg includes a free end. The first leg includes an outer surface and a toothed inner surface. The first leg is designed to project outwardly beyond the crosspiece in a convex manner. The first leg is resiliently flexible. The second leg is attached to and extends from the crosspiece. The second leg is aligned with and a distance from the first leg to define a receiving space for bottle tops. The second leg is similar to the first leg. The first leg, the second leg, and the crosspiece together define a C-shaped profile. The second leg is resiliently flexible such that the first leg and the second leg are manually compressible toward one another to grip bottle tops.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to a bottle opener and more particularly pertains to a new handheld bottle opener for use by flight attendants. In the airline industry, one of the several jobs of a flight attendant is to serve food and refreshments. The flight attendants routinely open dozens and dozens of bottles and cans of various types and sizes, such as beverage cans with metal pull tabs, miniature beverage bottles with screw caps, and regular-sized beverage bottles with screw caps or crown caps. This exercise can become quite difficult over a full work day, especially for flight attendants with limited grip strength due to physical build, age, or medical condition, such as arthritis or carpal tunnel, the symptoms and effects of which can be exacerbated by the repeated motion. The new handheld bottle opener can be used to reduce the effort for bottles and cans of all types and sizes. In addition, for safety reasons most all airlines worldwide have restrictions on the types of objects that can be carried onto an airplane, with special consideration for objects that could be used as weapons against the flight crew or passengers. The new handheld bottle opener is small and made of non-metallic materials to comply with these safety requirements, such as the guidelines issued by the federal Travel Safety Administration (TSA) in the U.S.

### (2) Description of Related Art including information disclosed under 37 CFR 1.97 and 1.98.

The prior art relates to bottle and jar openers and discloses mounted designs, such as for attaching to kitchen cabinets, and some handheld designs. The prior art, as best understood, does not disclose a handheld bottle opener for flight attendants that includes a crosspiece, a first leg, and a second leg, wherein each of the first leg and the second leg are resiliently flexible. The second leg is positioned in alignment with and a distance from the first leg to define a receiving space for bottle tops of beverage bottles. The second leg is designed to project outwardly beyond the crosspiece in a convex manner such that the first leg, the second leg, and the crosspiece together define a C-shaped profile. The second leg is resiliently flexible such that the first leg and the second leg are manually compressible toward one another to grip bottle tops of different diameters with the toothed inner surfaces.

### (h) BRIEF SUMMARY OF THE INVENTION

An embodiment of the disclosure meets the needs presented above in a handheld bottle opener generally comprising a crosspiece, a first leg, and a second leg. The first leg is attached to and extending from the crosspiece. The first leg includes a free end distal to the crosspiece. The first leg includes an outer surface is smooth and a toothed inner surface. The first leg is designed to project outwardly beyond the crosspiece in a convex manner. The first leg is resiliently flexible. The second leg is attached to and extending from the crosspiece. The second leg is positioned in alignment with and a distance from the first leg to define a receiving space for bottle tops of beverage bottles. The second leg includes a free end distal to the crosspiece. The second leg includes an outer surface is smooth and a toothed inner surface. The second leg is designed to project outwardly beyond the crosspiece in a convex manner such that the first leg, the second leg, and the crosspiece together define a C-shaped profile. The second leg is resiliently flexible such that the first leg and the second leg are manually compressible toward one another to grip bottle tops of different diameters with the toothed inner surfaces.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a handheld bottle opener according to an embodiment of the disclosure.

FIG. 2 is a bottom view of an embodiment of the disclosure.

FIG. 3 is a top view of an embodiment of the disclosure.

FIG. 4 is a right side view of an embodiment of the disclosure.

FIG. 5 is a left side view of an embodiment of the disclosure.

FIG. 6 is a perspective view of an embodiment of the disclosure in use with a regular-sized bottle.

FIG. 7 is a perspective view of an embodiment of the disclosure in use with a can having a pull tab.

FIG. 8 is a perspective view of an embodiment of the disclosure in use with a miniature-sized bottle.

FIG. 9 is a perspective view of a first alternative embodiment of the disclosure.

FIG. 10 is a perspective view of a second alternative embodiment of the disclosure.

### (j) DETAILED DESCRIPTION OF THE INVENTION

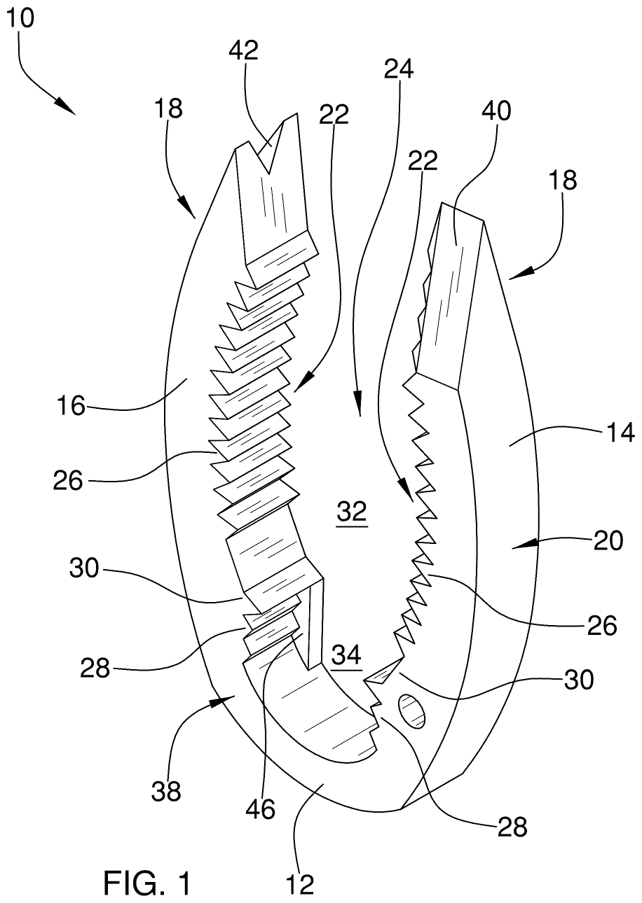

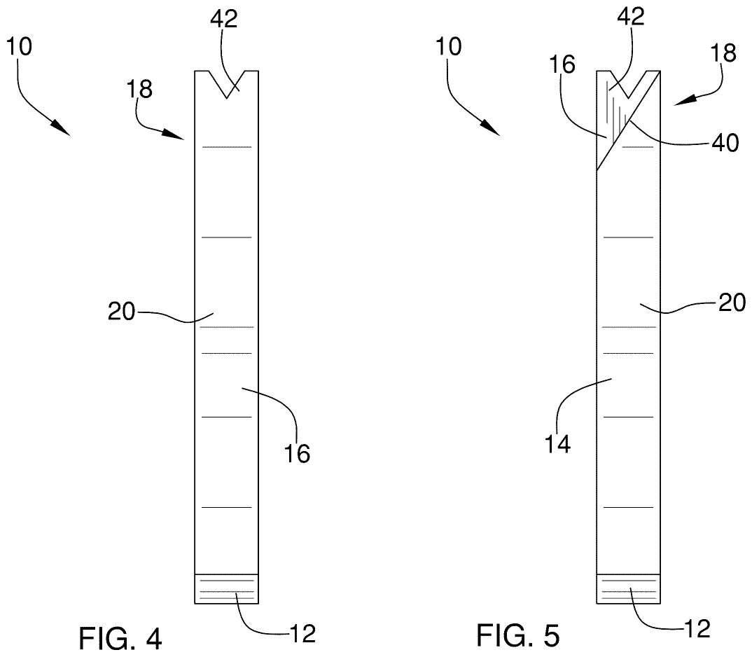

With reference now to the drawings, and in particular to FIGS. 1 through 10 thereof, a new handheld bottle opener embodying the principles and concepts of an embodiment of the disclosure and generally designated by the reference numeral 10 will be described.

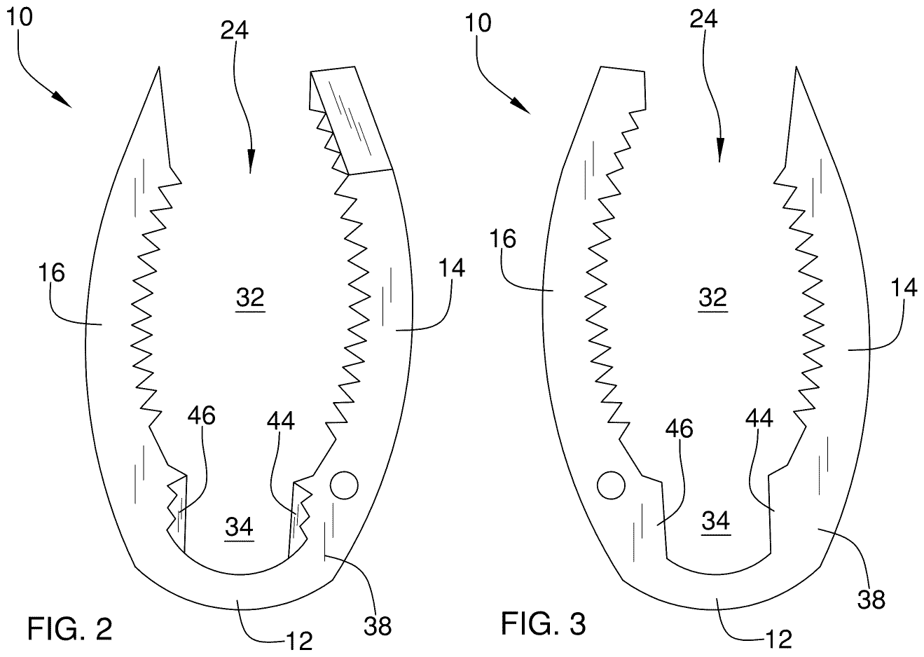

As best illustrated in FIGS. 1 through 10, the handheld bottle opener 10 generally comprises a crosspiece 12, a first leg 14, and a second leg 16. It should be noted that similar structures on each of the first leg 12 and the second leg 14 are marked with the same reference numerals for convenience. As shown in FIG. 1, the first leg 14 is attached to and extends from the crosspiece 12. The first leg 14 includes a free end 18 distal to the crosspiece 12. The first leg 14 includes an outer surface 20 that is smooth and a toothed inner surface 22. The first leg 14 is designed to project outwardly beyond the crosspiece 12 in a convex manner, as best seen in FIG. 2. The first leg 14 is resiliently flexible. The second leg 16 is attached to and extends from the crosspiece 12. The second leg 16 is positioned in alignment with and a distance from the first leg 14 to define a receiving space 24 for bottle tops 72 of beverage bottles 70. The second leg 16 includes a free end 18 distal to the crosspiece 12. The second leg 16 includes an outer surface 20 that is smooth and a toothed inner surface 22. The second leg 16 is designed to project outwardly beyond the crosspiece 12 in a convex manner such that the first leg 14, the second leg 16, and the crosspiece 12 together define a C-shaped profile. The second leg 16 is resiliently flexible such that the first leg 14 and the second leg 16 are manually compressible toward one another to grip bottle tops 72 of different diameters with the toothed inner surfaces 22.

As best seen in FIG. 2, each of the toothed inner surfaces 22 includes a first set of teeth 26 and a second set of teeth 28 separated by an interior protrusion 30. The first set of teeth 26 of each of the first leg 14 and the second leg 16 are disposed further apart than the second set of teeth 28 of each of the first leg 14 and the second leg 16 such that the receiving space 24 is divided into a larger receiving space portion 32 designed to receive regular-sized bottle tops 72 and a smaller receiving space portion 34 designed to receive miniature-sized bottle tops 72. For flight attendants, it is common to have to open regular-sized bottles 70 and miniature-sized bottles 70, also know as airline bottles. The exemplary embodiment of the handheld bottle opener 10 shown in FIG. 2 allows the flight attendant to easily open both kinds with one tool.

Each of the first leg 14 and the second leg 16 includes a top surface 36 and a bottom surface 38 that is perpendicular to the outer surface 20. While the top surface 36 and the bottom surface 38 are shown as being flat, they could possibly be rounded or contoured.

The free end 18 of one of the first leg 14 and the second leg 16 is in the shape of a wedge and includes an angled surface 40 that tapers between the top surface 36 and the bottom surface 38. In the exemplary embodiment in FIG. 1, the angled surface 40 is located on the first leg 14. In one possible embodiment, the angled surface 40 could be omitted.

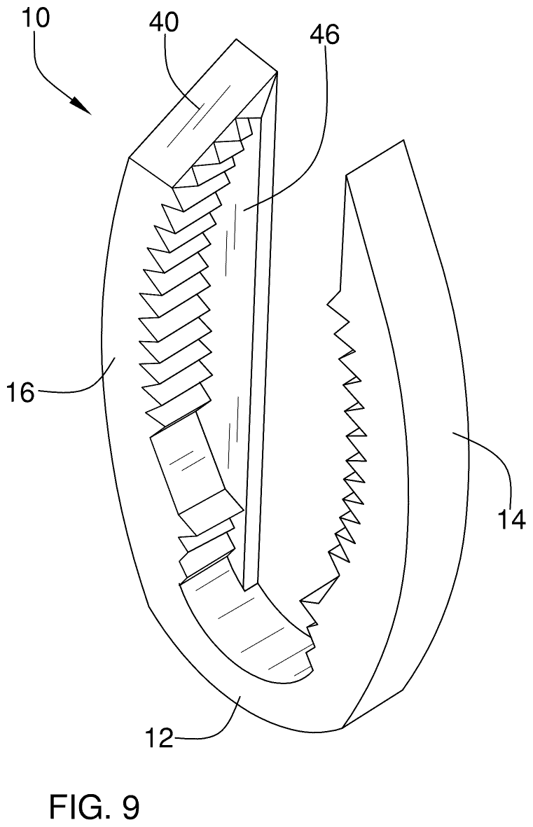

The free end 18 of one of the first leg 14 and the second leg 16 tapers to a toothed edge 42 perpendicular to the top surface 36 and the bottom surface 38. In the exemplary embodiment in FIG. 1, the toothed edge 42 is located on the second leg 16. In the first alternative embodiment in FIG. 9, the toothed edge 42 is omitted. The toothed edge 42 can be used to pry open tabs or lids of containers. The toothed edge 42 can also be used to puncture packaging, such as bags, pouches, containers, and beverage boxes.

As shown in FIG. 2, the first leg 14 includes a first stop panel 44 projecting inwardly from the top surface 36, and the second leg 16 includes a second stop panel 46 aligned with the first stop panel 44. In one possible embodiment there could be only one stop panel on either the first leg 14 or the second leg 16, Each of the first stop panel 44 and the second stop panel 46 is designed to engage a top exterior surface of a bottle top 72 when the bottle top 72 is inserted in the receiving space 24. Each of the first stop panel 44 and the second stop panel 46 is positioned to project solely into the smaller receiving space portion 34. However, as shown in the first alternative embodiment in FIG. 9, the each of the first stop panel 44 and the second stop panel 46 could extend along the length of the receiving space 24. The stop panels 44, 46 are used as a guide when gripping a bottle top 72.

Each of the crosspiece 12, the first leg 14, and the second leg 16 is made of plastic and integrally formed in a one-piece structure. Due to airline regulations, many different types of metal objects are prohibited, especially those that could be used as weapons, so the use of plastic is critical for compliance with airline regulations.

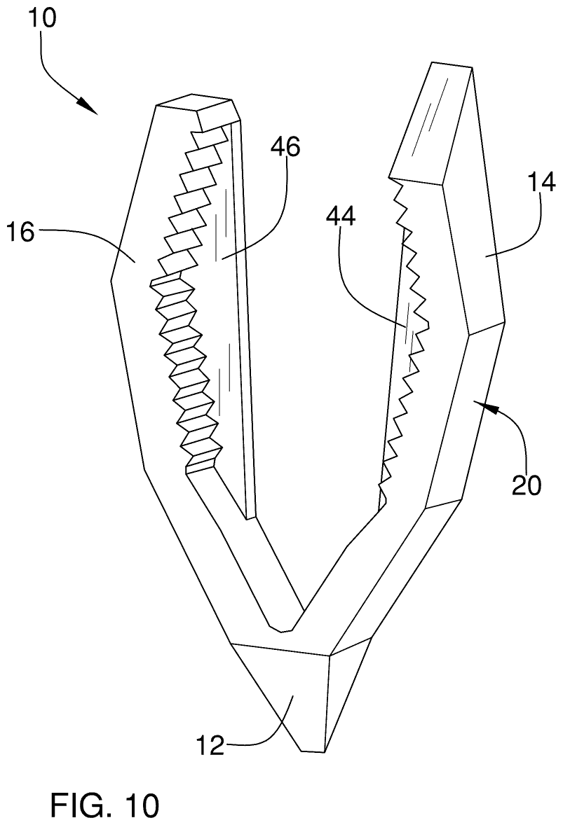

In the exemplary embodiment in FIGS. 1 through 5, each of the outer surfaces 20 has a continuous curvature. In contrast, in the second alternative embodiment in FIG. 10, each of the outer surfaces 20 includes a plurality of flat planar surfaces arranged at angles. Essentially any variation of the design of the outer surfaces 20 is within the scope of the disclosure provided the first leg 14 and the second leg 16 are convex for ergonomic purposes. In the exemplary embodiment in FIGS. 1 through 5, the crosspiece 12 has a curved end surface continuous with the outer surfaces 20 of the first leg 14 and the second leg 16. In contrast, in the second alternative embodiment in FIG. 10, the crosspiece 12 has an angled end surface.

The handheld bottle opener 10 should be small enough to be handheld and easily transported, such as in a pocket of pants or a shirt, as well as comply with airline regulations. In the exemplary embodiment, each of the first leg 14 and the second leg 16 has a maximum length of 100 mm and a maximum thickness of 15 mm. The receiving space 24 has a maximum diameter of 45 mm. It should be noted that these are merely exemplary maximum dimensions, and they could be adjusted to be smaller or larger as desired. In addition, while this design is primarily for use by flight attendants on airplanes, the handheld bottle opener 10 could be used in other industries that may have safety restrictions, such as cruise ships or trains, or for personal use outside these industries.

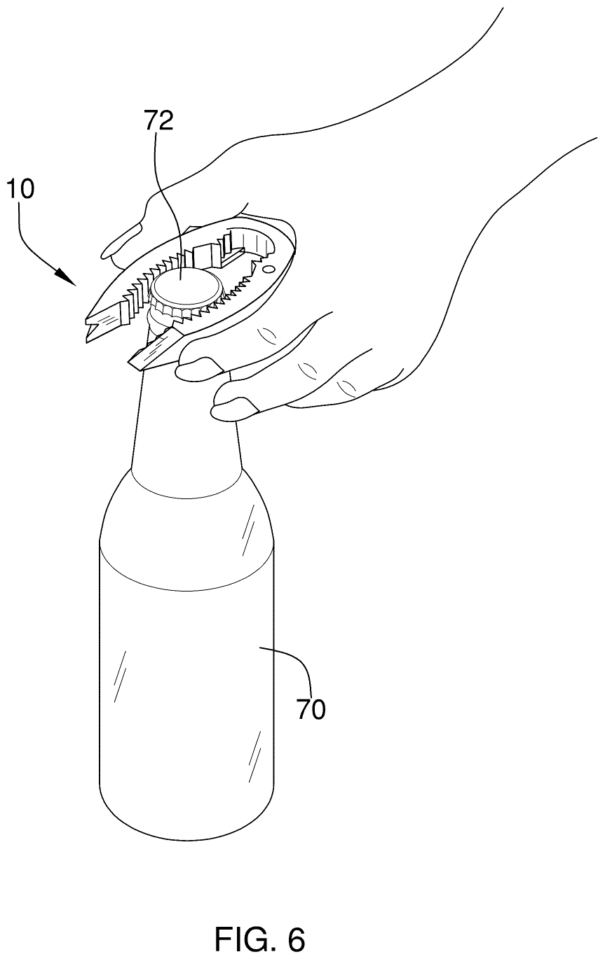

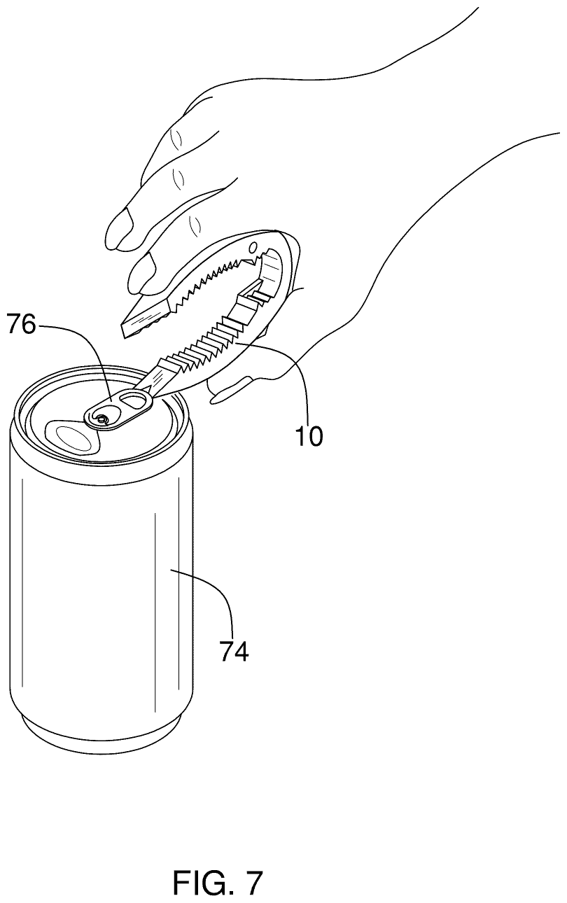

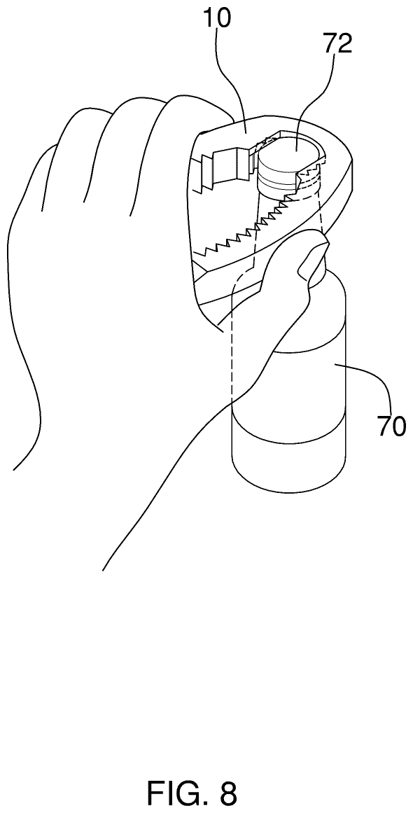

FIG. 6 shows one possible use of the handheld bottle opener 10. A user places a bottle top 72 of a beverage bottle 70, in this case a regular-sized twist-off cap, in the receiving space 24 between the toothed inner surfaces 22. The user then holds the first leg 14 and the second leg 16 between a thumb and at least one finger, in this case the index finger. The user then squeezes the first leg 14 and the second leg 16 together and thereby grips the bottle top 72 with the toothed inner surfaces 22. The user then removes the bottle top 72, such as by twisting and lifting. FIG. 7 shows a possible use with a can 74, wherein the user is utilizing the toothed edge 42 to pry up the pull tab 76. The user could alternatively use the wedge. The toothed edge 42 and the wedge could also be used to pry off crown caps.

FIG. 8 shows the removal of a miniature-sized bottle top 72 of a miniature-sized beverage bottle 70. The user places the miniature-sized bottle top 72 in the smaller receiving space portion 34 between the toothed inner surfaces 22. The user then holds the first leg 14 and the second leg 16 between a thumb and at least one finger, in this case two or three fingers in an overhand grip. The user then squeezes the first leg 14 and the second leg 16 together and thereby grips the miniature-sized bottle top 72 with the second set of teeth 28 of each of the first leg 14 and the second leg 16. The first stop and the second stop are used as guides to ensure that only the miniature-sized bottle top 72, and not the neck or body of the miniature-sized beverage bottle 70, is gripped by the second set of teeth 28 of each of the first leg 14 and the second leg 16. The user then removes the miniature-sized bottle top 72 by twisting.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A handheld bottle opener for flight attendants comprising:
a crosspiece;
a first leg being attached to and extending from said crosspiece, said first leg including a free end distal to said crosspiece, said first leg including an outer surface being smooth and a toothed inner surface, said first leg being configured to project outwardly beyond said crosspiece in a convex manner, said first leg being resiliently flexible; and
a second leg being attached to and extending from said crosspiece, said second leg being positioned in alignment with and a distance from said first leg to define a receiving space for bottle tops of beverage bottles, said second leg including a free end distal to said crosspiece, said second leg including an outer surface being smooth and a toothed inner surface, said second leg being configured to project outwardly beyond said crosspiece in a convex manner such that said first leg, said second leg, and said crosspiece together define a C-shaped profile, said second leg being resiliently flexible such that said first leg and said second leg are manually compressible toward one another to grip bottle tops of different diameters with said toothed inner surfaces.

2. The handheld bottle opener of claim 1, wherein:
each of said toothed inner surfaces includes a first set of teeth and a second set of teeth separated by an interior protrusion; and
said first set of teeth of each of said first leg and said second leg are disposed further apart than said second set of teeth of each of said first leg and said second leg such that said receiving space is divided into a larger receiving space portion configured to receive regular-sized bottle tops and a smaller receiving space portion configured to receive miniature-sized bottle tops.

3. The handheld bottle opener of claim 1, wherein each of said first leg and said second leg includes a top surface and a bottom surface being perpendicular to said outer surface.

4. The handheld bottle opener of claim 3, wherein said free end of one of said first leg and said second leg is in the shape of a wedge and includes an angled surface that tapers between said top surface and said bottom surface.

5. The handheld bottle opener of claim 3, wherein said free end of one of said first leg and said second leg tapers to a toothed edge perpendicular to said top surface and said bottom surface.

6. The handheld bottle opener of claim 3, wherein:
said first leg includes a stop panel projecting inwardly from said top surface; and
said stop panel is configured to engage a top exterior surface of a bottle top when the bottle top is inserted in said receiving space.

7. The handheld bottle opener of claim 6, wherein:
said stop panel of said first leg is a first stop panel; and
said second leg includes a second stop panel aligned with said first stop panel.

8. The handheld bottle opener of claim 1, wherein each of said crosspiece, said first leg, and said second leg is made of plastic and integrally formed in a one-piece structure.

9. The handheld bottle opener of claim 1, wherein each of said outer surfaces has a continuous curvature.

10. The handheld bottle opener of claim 1, wherein each of said outer surfaces includes a plurality of flat planar surfaces arranged at angles.

11. The handheld bottle opener of claim 1, wherein said crosspiece has a curved end surface continuous with said outer surfaces of said first leg and said second leg.

12. The handheld bottle opener of claim 1, wherein:
each of said first leg and said second leg has a maximum length of 100 mm;
each of said first leg and said second leg has a maximum thickness of 15 mm; and
said receiving space has a maximum diameter of 45 mm.

13. The handheld bottle opener of claim 2, wherein each of said first leg and said second leg includes a top surface and a bottom surface being perpendicular to said outer surface.

14. The handheld bottle opener of claim 13, wherein:
said free end of said first leg and is in the shape of a wedge and includes an angled surface that tapers from said bottom surface to said top surface; and
said free end of said second leg tapers to a toothed edge perpendicular to said top surface and said bottom surface.

16. The handheld bottle opener of claim 15, wherein:
said first leg includes a stop panel projecting inwardly from said top surface; and
said stop panel is configured to engage a top exterior surface of a bottle top when the bottle top is inserted in said receiving space.

17. The handheld bottle opener of claim 16, wherein:
said stop panel of said first leg is a first stop panel;
said second leg includes a second stop panel aligned with said first stop panel; and
each of said first stop panel and said second stop panel is positioned to project solely into said smaller receiving space portion.

18. The handheld bottle opener of claim 17, wherein:
each of said crosspiece, said first leg, and said second leg is made of plastic and integrally formed in a one-piece structure;
each of said outer surfaces has a continuous curvature;
said crosspiece has a curved end surface continuous with said outer surfaces of said first leg and said second leg;
each of said first leg and said second leg has a maximum length of 100 mm;
each of said first leg and said second leg has a maximum thickness of 15 mm; and
said receiving space has a maximum diameter of 45 mm.

19. A method of opening beverage bottles on an airplane, said method comprising the steps of:
providing a handheld bottle opener for flight attendants comprising:
a crosspiece;
a first leg being attached to and extending from said crosspiece, said first leg including a free end distal to said crosspiece, said first leg including an outer surface being smooth and a toothed inner surface, said first leg being configured to project outwardly beyond said crosspiece in a convex manner, said first leg being resiliently flexible; and
a second leg being attached to and extending from said crosspiece, said second leg being positioned in alignment with and a distance from said first leg to define a receiving space for bottle tops of beverage bottles, said second leg including a free end distal to said crosspiece, said second leg including an outer surface being smooth and a toothed inner surface, said second leg being configured to project outwardly beyond said crosspiece in a convex manner such that said first leg, said second leg, and said crosspiece together define a C-shaped profile, said second leg being resiliently flexible such that said first leg and said second leg are manually compressible toward one another to grip bottle tops of different diameters with said toothed inner surfaces;
placing a bottle top of a beverage bottle in said receiving space between said toothed inner surfaces;
holding said first leg and said second leg between a thumb and at least one finger;
squeezing said first leg and said second leg together and gripping the bottle top with said toothed inner surfaces; and
removing the bottle top.

20. The method of claim 19, wherein:
each of said toothed inner surfaces includes a first set of teeth and a second set of teeth separated by an interior protrusion;
said first set of teeth of each of said first leg and said second leg are disposed further apart than said second set of teeth of each of said first leg and said second leg such that said receiving space is divided into a larger receiving space portion configured to receive regular-sized bottle tops and a smaller receiving space portion configured to receive miniature-sized bottle tops; and
said method further comprises:
placing a miniature-sized bottle top of a miniature-sized beverage bottle in said smaller receiving space portion between said toothed inner surfaces;
holding said first leg and said second leg between a thumb and at least one finger;
squeezing said first leg and said second leg together and gripping the miniature-sized bottle top with said second set of teeth of each of said first leg and said second leg; and
removing the miniature-sized bottle top.
